(19) United States
(12) Patent Application Publication
(10) Pub. No.: US 2009/0043749 A1
(43) Pub. Date: Feb. 12, 2009

(54) EXTRACTING QUERY INTENT FROM QUERY LOGS

(76) Inventors: Priyank S. Garg, San Jose, CA (US); Kostas Tsioutsiouliklis, San Jose, CA (US); Bruce T. Smith, San Francisco, CA (US); Timothy M. Converse, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/834,619

(22) Filed: Aug. 6, 2007

(51) Int. Cl. G06F 7/06; G06F 17/30

(52) U.S. Cl. 707/5; 707/101; 707/E17.017

(57) ABSTRACT

Techniques are provided for storing queries received by a search engine are in a query log. For a particular query term in the query, it is determined how many queries in the query log contain that particular query term and an intent-indicating term, and determined how many queries in the query log contain that particular query term without an intent-indicating term. Based on the ratio between the number of queries in the query log that contain the particular query term and the intent-indicating term and the number of queries in the query log that contain the particular query term without the intent-indicating term, it is determined whether the particular query term is an intent-qualified query term. In response to determining that the particular query term is an intent-qualified query term, data is stored in a computer-readable medium that identifies the query term as an intent-qualified query term. Implicit-intent queries that contain the intent-qualified query term are processed based, at least in part, on the intent associated with the intent-qualified query term.

### RELATED APPLICATION DATA

This application is related to co-pending U.S. patent application Ser. No. ______, entitled “Estimating the Date Relevance of a Query from Query Logs,” filed on same day herewith (Attorney Docket Number 50269-0920), the entire disclosure of which is incorporated by reference as if fully set forth herein.

### FIELD OF THE INVENTION

The present invention relates to Internet searching and, more specifically, to identifying particular types of queries.

### BACKGROUND

As the amount of content, such as documents, images, videos and sound files, proliferates on the Internet, users have begun to rely more heavily on Internet search engines to locate and view content in which they are interested. One example of a search engine is a computer program designed to find documents stored in a computer system, such as the World Wide Web. The search engine's tasks typically include finding documents, analyzing documents, and building an index that supports efficient document retrieval.

A user describes the documents she is seeking with a query. In a common case, a query is a set of words, which should appear in the documents. Web sites such as Yahoo™ offer the capability to search for content on the Internet that is deemed relevant to a search query, such as web pages and multimedia, among other categories. In response to a query, the web site performing the search query may display content extracted from other web sites in addition to links to content.

Query logs are a collection of user-submitted queries over a period of time. The collection may be supplemented by additional data, such as cookies, search results, click-through data, and other data. Each document returned by the search engine in response to the user's query is a result. A search results page is a web page that displays the result documents' web addresses along with other information, such as titles, summaries, thumbnail images, and/or other information. A document's rank for a given query is the position in which the document appears on the search results page. A document's rank indicates that the search engine evaluated it more relevant to the user's query than lower-ranked documents.

One problem faced by search engines and their users is that certain queries have an unstated, inherent intent that influences what set of results would be considered best by the user submitting the query. For example, a user may submit a query without a date component with the intent of obtaining results related to a particular date. For example, in November 2006, a user searches for the query “Olympics.” The best and most relevant results depend on what year Olympics the user is looking for. Is the user looking for the 2004 Summer Olympics in Athens, the 2006 Winter Olympics in Turin, the 2008 Summer Olympics in China, or some other Olympics? Another example is a user searching for “Honda Accord.” The best and most relevant results depend on whether the user desires information about the current model or a past or future model. These may be considered “time-sensitive” queries, which are queries with an implicit time component. Often, time-sensitive queries state a date explicitly, but that is not always the case. In the above example, “Olympics” is a time-sensitive query, but the date is assumed implicitly.

Time-sensitive queries are one example of queries that may contain “intent-indicating query terms”. Intent-indicating query terms are keywords present in a query that evince a particular intent. In the previous examples, the intent-indicating query terms are dates. Another example of an intent-indicating query term is the word “buy,” which when associated with a product name, such as iPod™ indicates an intent to purchase the product. The word “review,” which when associated with a product name indicates an intent to perform research on the product. Another type of intent may be inferred from a place name, such as “library,” which when combined with a place, such as an associated query term such as “San Jose” or place data determined from other information, such as the IP address of the user performing the search, indicates a “local” intent.

Sometimes, users submit queries with a particular intent, but which fail to include intent-indicating query terms. Such queries are said to have an “implicit” intent. The search engine faces two problems when attempting to deal with queries with implicit intent. First, the search engine needs to identify which queries have implicit intent. Second, the search engine must identify which documents best relate to the query and respond to the query's implicit intent.

Current approaches to identifying and responding to queries are to take the text in a user's query, match that text to a property of a document indexed by the search engine, rank the results based upon various criteria such as number of times the search term appears in the document, how many other web pages link to the document returned in response to the query, or to rank the results procured by date of creation or modification of the particular web page result.

These approaches are inadequate for several reasons. The approaches do not offer a technique for identifying particular queries that may have an implicit intent; for example, a query without a date where a date may be implied. Further, the approaches for ranking documents, such as sorting by date of creation or modification, do not specifically address the situation where the most relevant document may not be the most recently added or modified document.

Therefore, an approach for identifying searches with an implicit intent and returning and ranking results in response to such queries, which does not experience the disadvantages of the above approaches, is desirable. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system according to an embodiment of the invention;

FIG. 2 is a block diagram illustrating an example flow and analyzation of data according to an embodiment of the invention;

FIG. 3 is a flowchart illustrating the functional steps of identifying and designating queries as date-qualified, according to an embodiment of the invention; and

FIG. 4 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are provided for determining whether a particular query has an implicit intent, and for processing queries that have implicit intents based on their corresponding intents.

According to an embodiment, an approach is provided where queries received by a search engine are stored in a query log. For a particular query term in the query, it is determined how many queries in the query log contain that particular query term and an intent-indicating term, such as “shopping” or “review,” and it is determined how many queries in the query log contain that particular query term without an intent-indicating term. Based on the ratio between the number of queries in the query log that contain the particular query term and an intent-indicating term and the number of queries in the query log that contain the particular query term without an intent-indicating term, it is determined whether the particular query term is an intent-qualified query term. In response to determining that the particular query term is an intent-qualified query term, data is stored in a computer-readable medium that identifies the query term as an intent-qualified query term.

Examples are given hereafter where the implicit intent has a time component. For example, embodiments are described in which queries received by a search engine are stored in a query log. For a particular query term in the query, it is determined how many queries in the query log contain that particular query term and a date, and determined how many queries in the query log contain that particular query term without a date. Based on the ratio between the number of queries in the query log that contain the particular query term and a date and the number of queries in the query log that contain the particular query term without a date, it is determined whether the particular query term is a date-qualified query term. In response to determining that the particular query term is a date-qualified query term, data is stored in a computer-readable medium that identifies the query term as a date-qualified query term.

### Architectural Overview

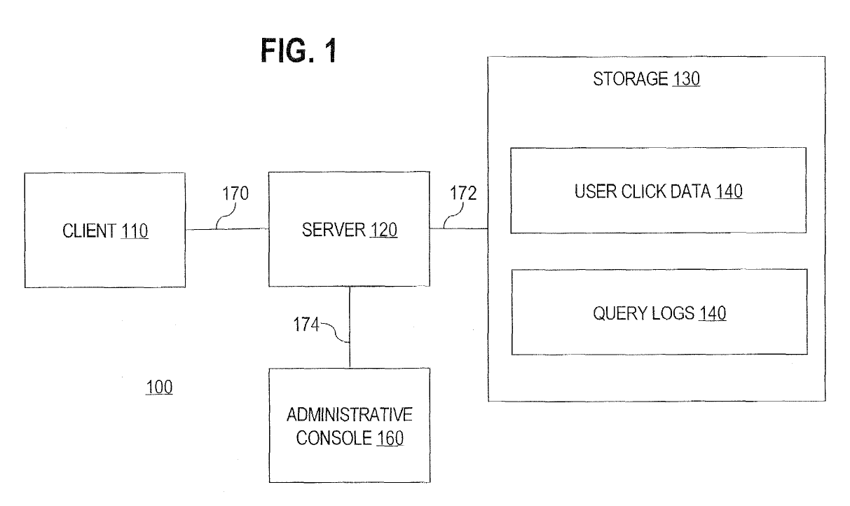

FIG. 1 is a block diagram of a system 100 according to an embodiment of the invention. Embodiments of system 100 may be used to identify potentially offensive content in accordance with an embodiment of the invention.

In the embodiment depicted in FIG. 1, system 100 includes client 110, server 120, storage 130, user click data 140, query logs 150, and an administrative console 160. While client 110, server 120, storage 130, and administrative console 160 are each depicted in FIG. 1 as separate entities, in other embodiments of the invention, two or more of client 110, server 120, storage 130, and administrative console 160 may be implemented on the same computer system. Also, other embodiments of the invention (not depicted in FIG. 1), may lack one or more components depicted in FIG. 1, e.g., certain embodiments may not have an administrative console 160, may lack query logs 150, or may combine one or more of the user click data 140 and query logs 150 into a single index or file.

Although embodiments of the invention are depicted in the figures and described herein in the context of having a client 110, server 120, storage 130, user click data 140, query logs 150, and an administrative console 160, the functionality of these elements may be combined into a single element or implemented in any number of separate elements. Furthermore, the functionality of the client 110, server 120, storage 130, user click data 140, query logs 150, and an administrative console 160 may be implemented in hardware, software, or any combination of hardware and software, depending upon a particular implementation.

Client 110 may be implemented by any medium or mechanism that provides for sending request data, over communications link 170, to server 120. Request data specifies a search query that may contain terms about which the user desires to find content on the Internet.

The server, after processing the request data, will transmit to client 110 response data that returns content identified as relevant for a particular query. While only one client 110 is depicted in FIG. 1, other embodiments may employ two or more clients 110, each operationally connected to server 120 via communications link 170, in system 100. Non-limiting, illustrative examples of client 110 include a web browser, a wireless device, a cell phone, a personal computer, a personal digital assistant (PDA), and a software application.

Server 120 may be implemented by any medium or mechanism that provides for receiving request data from client 110, processing the request data, and transmitting response data that identifies the content identified as relevant for a particular query to client 110.

Storage 130 may be implemented by any medium or mechanism that provides for storing data. Non-limiting, illustrative examples of storage 130 include volatile memory, non-volatile memory, a database, a database management system (DBMS), a file server, flash memory, and a hard disk drive (HDD). In the embodiment depicted in FIG. 1, storage 130 stores the user click data 140 and query logs 150. In other embodiments (not depicted in FIG. 1), the user click data 140 and query logs 150 may be stored across two or more separate locations, such as two or more storages 130.

User click data 140 represents data recording each time a user clicks on content returned in response to a search. According to an embodiment, this is a user click log and is accomplished by recording the click and associating the click with the unique identifier associated with the item clicked upon, as described further herein. For example, if a search returns a link to a web page and an image, and the user clicks on the image, the user click data 140 will record that the particular image was clicked. If the user then returns to the search results and clicks the link to a web page, the user click data 140 will record that the particular link was clicked. Query logs 150 comprise a collection of user-submitted queries over a period of time. According to an embodiment, the query logs 150 are indexed to provide faster retrieval.

Administrative console 160 may be implemented by any medium or mechanism for performing administrative activities in system 100. For example, in an embodiment, administrative console 160 presents an interface to an administrator, which the administrator may use to add to, remove or modify data in the user click data 140, add to, remove or modify content from the query logs 150, or create an index on storage 130, or configure the operation of server 120.

Communications link 170 may be implemented by any medium or mechanism that provides for the exchange of data between client 110 and server 120. Communications link 172 may be implemented by any medium or mechanism that provides for the exchange of data between server 120 and storage 130. Communications link 174 may be implemented by any medium or mechanism that provides for the exchange of data between administrative console 160, server 120, and storage 130. Examples of communications links 170, 172, and 174 include, without limitation, a network such as a Local Area Network (LAN), Wide Area Network (WAN), Ethernet or the Internet, or one or more terrestrial, satellite or wireless links

### Extracting and Identifying Query Intent Using Query Logs

A time-sensitive query is a query where the time at which the query is issued affects which search results are most relevant. For example, the query “spiderman movie” is a time sensitive query because the most relevant search results for the query will vary depending on whether the query is submitted immediately after the release of Spiderman 1, or immediately after the release of Spiderman 2.

A date-qualified query is a time-sensitive query that is frequently accompanied by time-indicating words. In many cases, the time-indicating words may be dates. For example, “olympics” is a time-sensitive date-qualified query, because queries such as “olympics 2004” and “olympics 2008” are common in the query logs. Other time-sensitive date-qualified queries may frequently be accompanied by time-indicating words that are not explicit dates. Such non-date time-indicating words include, for example, “yesterday”, “last year”, “spring”, “fall”, etc.

As mentioned above, one example an implicit intent query is a date-qualified query that does not include a date. However, in order to handle date-qualified queries that do not include dates, it is first necessary to be able to identify which queries qualify as date-qualified queries. Various approaches are described herein for identifying date-qualified queries. In one embodiment, data containing queries, such as query logs or a live stream of queries, is collected and analyzed to determine which query terms are date-qualified. When future queries are received containing these date-qualified query terms, the results may be ranked accordingly, as described further herein.

As an example, let “Olympics” be a query from the query logs. The query logs are analyzed and the following queries are found: “Olympics 2004,” “2006 Olympics,” and “2008 Olympics.” Since “Olympics” next to a date exists in the query logs, it may be determined that “Olympics” is a date-qualified query. The queries “Olympics 2004,” “2006 Olympics,” and “2008 Olympics” may also be considered date-qualified.

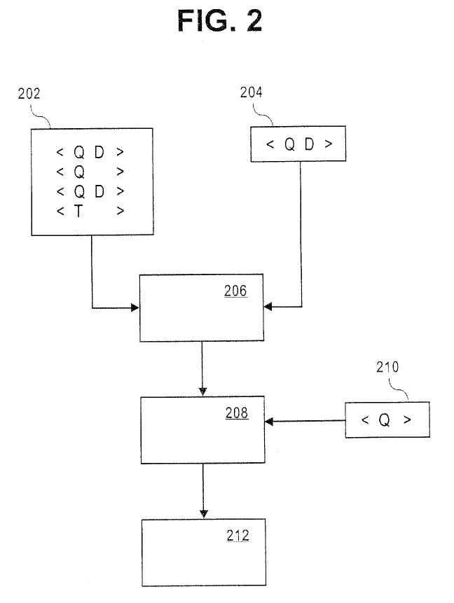

FIG. 2 is a block diagram illustrating an example flow and analyzation of data according to an embodiment of the invention. Although embodiments of the invention are depicted in the figures and described herein in the context of having a query log 202, one or more queries from a live stream 204, an analyzation engine 206, another element 208 such as a search engine, and a set of results 212, the functionality of these elements may be combined into a single element or implemented in any number of separate elements. Furthermore, the functionality of the query log 202, one or more queries from a live stream 204, an analyzation engine 206, another element 208 such as a search engine, and a set of results 212 may be implemented in hardware, software, or any combination of hardware and software, depending upon a particular implementation

In FIG. 2, query data is collected and transmitted in order to analyze the query data. The query data may be in the form of a query log 202, for example in a database, or one or more queries from a live stream 204 being submitted by users. The query logs may be specific; for example, only queries from the last month. In the example embodiment, <Q> is a query in the query logs, such as “Olympics.” If <Q D> is located in the query logs, where <D> is a date, then <Q> and <Q D> may be designated as date-qualified. The set of all date-qualified queries is the time-sensitive queries produced by the approaches described herein.

According to an embodiment, the term <Q> may be a single term or multiple terms. It may be normalized, such as reformulating the term in all lowercase or uppercase, removing white space, correcting spelling, and/or other actions. When the term or terms are normalized, both or either the original and normalized version may be designated as date-qualified.

A date <D> can be a date in any form identified as such. It is not restricted to a year, a month/day/year, or any other “standard” representations of dates. According to an embodiment, this is accomplished through pattern matching, where certain formats of dates are stored and components of queries are compared to the stored examples to determine whether the component is a date. Certain dates may be “false positives,” which are dates or numbers incorrectly identified as dates that are not contextually related to the query. For example, the query “Space Odyssey 2001” would not indicate a time-sensitive query. According to an embodiment, the dates used to identify a date-qualified query may be subject to a specified range. For example, only dates within 5 years of the current date may be identified and used in the determination, while all other dates are discarded for purposes of identifying date-qualified queries.

In FIG. 2, the query data 202, 204 is transmitted to an analyzation engine 206, which in various embodiments may comprise a search engine or similar process executing on a computer. According to an embodiment, the queries, such as <Q> and <Q D> are received and analyzed. If a query term <Q> is associated with a date, for example being preceded or followed by a year, then the query term <Q> is a candidate for inclusion as a date-qualified query. In an embodiment, the query term <Q> is designated as date-qualified if there exists at least one query of the form <Q D> in the query data 202, 204. In alternate embodiments, a particular ratio or threshold is used to determine whether a query should be designated as a date-qualified query. A single instance of <Q D> may be an error, such as a misspelling, on a user's part. Because date-qualified queries should be time-sensitive, <Q> should not be underrepresented in the instances where it appears in proximity to a date.

A ratio may be used to calculate a threshold value, above which a query may be designated as date-qualified. For example, a threshold ratio might be one in 100, where <Q> appears N times in the query data 202, 204, then if <Q D> appears at least N/100 times, the query <Q> may be designated as date-qualified. Given that <D> may appear as multiple dates and representations, they may be considered cumulatively or individually. In an embodiment, different representations of <D> corresponding to the same date are merged.

Instead of a discrete threshold, the frequency with which <Q D> appears in the query data 202, 204 may be used to calculate a score by which the query term <Q> may be evaluated. The score may be continuously updated and smoothed to account for outliers and skewed numbers; for example, the threshold may be adjusted based on an analysis of recent queries. In an embodiment, if it is determined that a particular ratio tends to indicate a date-qualified query, then the ratio data could be used as one part of a larger approach to determine date-qualified queries. False positives, such as “Space Odyssey” mentioned in above, can be reduced by requiring date qualified queries to appear in the query logs together with more than one year. E.g. “olympics” can be found next to “2004”, “2008”, etc. Queries that have only a single year attached to them are likely not time-sensitive.

Other types of data may be used to designate a query as date-qualified. For example, session data, which is data comprised of queries from a single user during a single search session, may indicate a likelihood of a date-qualified query. A user may submit a search query of “Olympics,” and then a search query of “Olympics 2004.” This progression of search terms may indicate that there is an implicit date element to the query term “Olympics.” User click logs may also be used; for example, if at least a particular ratio of users who submitted a query of “Olympics” were identified as clicking on a result that could be classified as being a date-sensitive document, such as the site for the 2008 Olympics, then this information could be used to determine whether a particular query term should be designated as date-qualified.

Once the analyzation engine 206 determines that a particular query term <Q> is a date-qualified query, that information may be communicated to another element 208, for example a search engine. In an embodiment, elements 206 and 208 may be combined. Search engine 208 then receives a query 210 that contains the date-qualified query term <Q>, for example alone or in combination with a date, and the search engine provides a set of results 212 ranked according to the techniques described further herein.

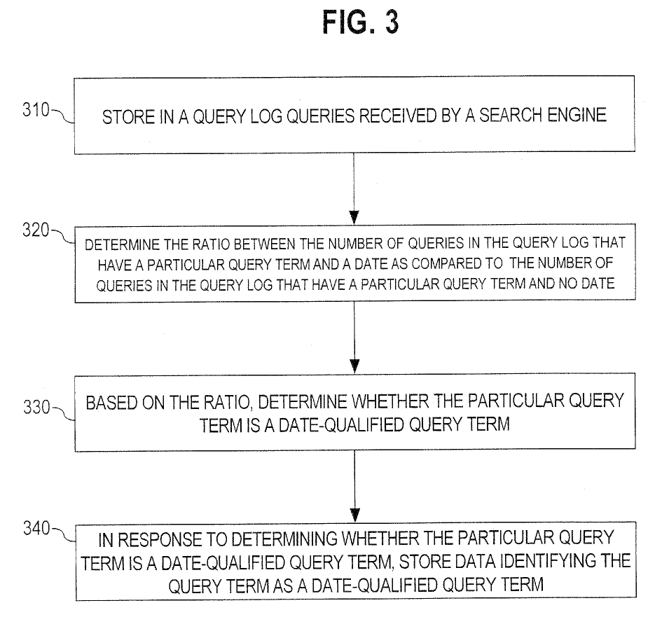

FIG. 3 is a flowchart illustrating the functional steps of identifying and designating queries as date-qualified, according to an embodiment of the invention. In step 310, queries received by a search engine are stored in a query log. The storage may be random-access memory storage or durable storage such as a hard drive. The query logs may consist of queries received in the past, or may be a continuously updating storage of queries. In step 320, for a particular query term, it is determined how many queries in the query log contain that particular query term and a date, and how many queries in the query log contain that particular query term without a date. It may also be determined how many total queries exist with the query term included.

In step 330, a ratio is calculated, and based on the ratio between the number of queries in the query log that contain the particular query term and a date and the number of queries in the query log that contain the particular query term without a date, it is determined whether the particular query term is a date-qualified query term. The ratio may also be between the number of queries in the query log that contain the particular query term and a date and the total number of queries in the query log that contain the particular query term. In an embodiment, the ratio is compared to a threshold value in order to determine whether the particular query term is a date-qualified query term.

In step 340, in response to determining that the particular query term is a date-qualified query term, data is stored in a computer-readable medium that identifies the query term as a date-qualified query term.

### Extracting and Identifying Intent-Qualified Query Terms Using Query Logs

While the above-described techniques have been described in the context of date-qualified queries, the techniques may be readily applied to other types of intent-qualified query terms. As explained above, an intent-qualified query term is a query that is submitted a particular intent; for example, a “shopping” intent or a “local” intent. If the query is issued with the particular intent, but does not include an intent-indicating term, the query is an implicit-intent query. Web logs may be used to determine which query terms are intent-qualified query terms. After determining that a particular query term is an intent-qualified query term, the search experience presented to users that submit implicit-intent queries that contain the particular query term may be modified, as discussed further herein.

As discussed herein, query data comprising user queries is received and analyzed. For each query term <Q>, it is determined whether another term evincing intent <I> is associated with the query term, for example being in proximity to the query term in the query data. If the query term <Q> is associated with data evincing an intent <Q I>, then the query term <Q> is a candidate for inclusion as an intent-qualified query term.

According to an embodiment, query data is transmitted to an analyzation engine, which in various embodiments may comprise a search engine or similar process executing on a computer. According to an embodiment, the queries, such as <Q> and <Q D> are received and analyzed. If a query term <Q> is associated with a date, for example being preceded or followed by a year, then the query term <Q> is a candidate for inclusion as a date-qualified query. In an embodiment, the query term <Q> is designated as intent-qualified if there exists at least one query of the form <Q I> in the query data. In alternate embodiments, a particular ratio or threshold is used to determine whether a query should be designated as an intent-qualified query term. A single instance of <Q I> may be an error, such as a misspelling, on a user's part.

Other types of data may be used to designate a query as intent-qualified. For example, session data, which is data comprised of queries from a single user during a single search session, may indicate a likelihood of an intent-qualified query term. A user may submit a search query of “iPod,” and then a search query of “iPod reviews.” This progression of search terms may indicate that there is an implicit intent element to the query term “iPod.” User click logs may also be used; for example, if at least a particular ratio of users who submitted a query of “iPod” were identified as clicking on a result that could be classified as being an intent-sensitive document, such as a site for iPod reviews, then this information could be used to determine whether a particular query term should be designated as intent-qualified.

According to an embodiment, the identification of a query term as an intent-qualified query term is a first step in determining how to treat queries containing the intent-qualified query term. For example, of all the occurrences of the query term associated with an intent <Q I>, such as “iPod review” and “iPod buy,” may be calculated as vectors to indicate what percentage of intents should be inferred to the search term. For example, if, out of the entire number of times a query term <Q> is associated with an intent <I>, a certain percentage is intent I1 and another percentage is intent I2, then the processing and presentation of search results may be adjusted accordingly, as discussed further herein.

For example, the query term “iPod” is determined to be an intent-qualified query term as a result of being associated with an intent <I> at a rate greater than a threshold value, or as a result of a score being of a particular value. Of the intents <I> associated with the query term “iPod,” 60% are the intent term “buy” and 40% are the research term “review.” As a result, the intents may be transformed into vectors which are applied to the search results.

Other examples of implicit intent include shopping/commercial intent, which may be indicated by query terms such as “review”, “price”, “coupons”, “free”. Entertainment intent may be indicated by query terms such as “lyrics”, “movie schedules”, “concert tickets”. Travel intent may be indicated by query terms such as “flights”. These are merely examples of types of intent that may be identified based on the content of web logs.

A mapping is maintained between the intent-qualified query terms, and the intents to which they correspond. This, the query term “iPod” may be mapped to both the purchase intent and the research intent. The query term “Olympics” may be mapped to the “2006” date intent. The query term “weather” may be mapped to the “local” intent. After establishing a mapping between intent-qualified query terms and their corresponding intents, the search engine may process queries that contained the intent-qualified query terms based on their corresponding intents, even when those queries are implicit-intent queries that do not contain intent-indicating terms.

Once the intent of an implicit-intent query has been identified, the search results ranking can be modified based on the intent. E.g. by promoting commercial pages for shopping-related queries. Instead of or in addition to modifying the search results ranking based on intent, queries can be automatically further refined based on inferred intent and context. E.g. for queries with local intent results may be limited to a geographical area, or for queries with time-sensitive intent preference may be given to recent document or to documents from the inferred time.

### Implementing Mechanisms

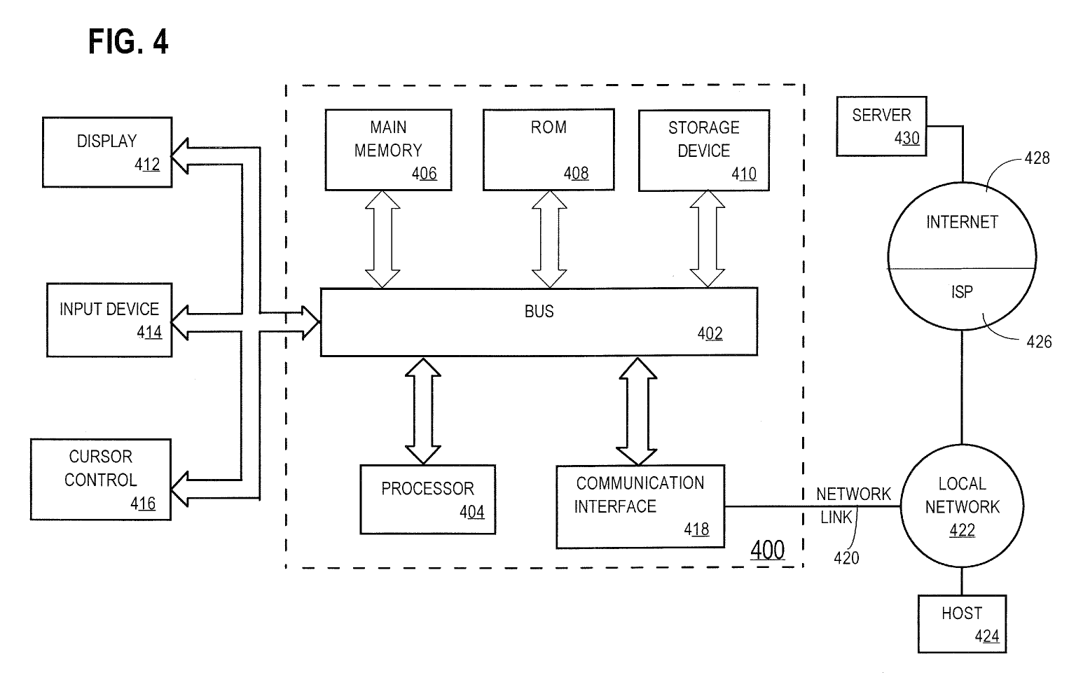

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method for categorizing a search query, the computer-implemented method comprising:
storing in a query log queries received by a search engine;
for a particular query term, determining how many queries in the query log contain that particular query term and an intent-indicating term, and determining how many queries in the query log contain that particular query term without an intent-indicating term;
based on the ratio between the number of queries in the query log that contain the particular query term and an intent-indicating term and the number of queries in the query log that contain the particular query term without an intent-indicating term, determining whether the particular query term is an intent-qualified query term; and
in response to determining that the particular query term is an intent-qualified query term, storing data in a computer-readable medium that identifies the query term as an intent-qualified query term.

2. The method of claim 1 further comprising:
receiving a query;
based on the data stored in the computer-readable medium, determining that the query is an implicit-intent query that includes an intent-qualified query term but does not include a particular intent-indicating term; and
returning query results for said query that are based, at least in part, on an implicit intent that corresponds to the particular intent-indicating term.

3. The computer-implemented method of claim 1, the intent-qualified query term is a term related to shopping.

4. The method of claim 1 wherein:
the intent-indicating term is a date;
the step of storing data in a computer-readable medium includes storing data that identifies the query term as a date-qualified query term.

5. The computer-implemented method of claim 4, wherein the ratio comprises a ratio between the number of queries in the query log that contain the particular query term and a date and the total number of queries in the query log that contain the particular query term, including the number of queries in the query log that contain the particular query term and a date.

6. The computer-implemented method of claim 1, wherein determining whether the particular query term is an intent-qualified query term comprises:
calculating the number of queries in the query log that contain the particular query term and said intent-indicating term;
comparing the number of queries in the query log that contain the particular query term and said intent-indicating term to a specified threshold;
if the number of queries in the query log that contain the particular query term and the intent-indicating term exceed the threshold, then determining that the particular query term is an intent-qualified query term.

7. The computer-implemented method of claim 6, wherein the threshold is based on user input.

8. The computer-implemented method of claim 6, wherein the threshold is adjusted based on an analysis of recent queries.

9. The computer-implemented method of claim 4, wherein the particular query term is normalized prior to determining how many queries in the query log contain that particular query term and a date, and determining how many queries in the query log contain that particular query term without a date.

10. The computer-implemented method of claim 4, wherein the date comprises a year.

11. The computer-implemented method of claim 10, wherein the year is designated as a date for the purpose of determining how many queries in the query log contain that particular query term and a date, and determining how many queries in the query log contain that particular query term without a date only if the year is within a specified number of years from the current year.

12. A method for handling implicit-intent queries, the method comprising:
determining, based on information about user behavior involving a search engine, a mapping between intent-qualified query terms and search intents;
receiving, at the search engine, an implicit-intent query that contains a particular intent-qualified query term; and
returning search results for said implicit-intent query that are based, at least in part, on a particular search intent to which the particular intent-qualified query term is mapped in said mapping.

13. The method of claim 12 wherein the information includes a log of queries submitted to the search engine.

14. The method of claim 12 wherein:
the information includes session data that indicates queries from a single user during a single search session; and
the particular search intent is mapped to the particular intent-qualified query term based, at least in part, on selection of an intent-sensitive document during said single search session.

15. The method of claim 12 wherein:
the particular intent-qualified query term is mapped to a plurality of intents; and
the method includes generating said search results based on said plurality of intents.

16. The method of claim 12 further comprising promoting pages within said search results based on said particular intent.

17. The method of claim 12 further comprising automatically further refining said query based on said particular intent.

18. A computer-readable medium carrying one or more sequences of instructions which, when executed by one or more processors, causes the one or more processors to perform the method recited in claim 1.

19. A computer-readable medium carrying one or more sequences of instructions which, when executed by one or more processors, causes the one or more processors to perform the method recited in claim 2.

20. A computer-readable medium carrying one or more sequences of instructions which, when executed by one or more processors, causes the one or more processors to perform the method recited in claim 3.

21. A computer-readable medium carrying one or more sequences of instructions which, when executed by one or more processors, causes the one or more processors to perform the method recited in claim 4.

22. A computer-readable medium carrying one or more sequences of instructions which, when executed by one or more processors, causes the one or more processors to perform the method recited in claim 5.

23. A computer-readable medium carrying one or more sequences of instructions which, when executed by one or more processors, causes the one or more processors to perform the method recited in claim 6.

24. A computer-readable medium carrying one or more sequences of instructions which, when executed by one or more processors, causes the one or more processors to perform the method recited in claim 7.

25. A computer-readable medium carrying one or more sequences of instructions which, when executed by one or more processors, causes the one or more processors to perform the method recited in claim 8.

26. A computer-readable medium carrying one or more sequences of instructions which, when executed by one or more processors, causes the one or more processors to perform the method recited in claim 9.

27. A computer-readable medium carrying one or more sequences of instructions which, when executed by one or more processors, causes the one or more processors to perform the method recited in claim 10.

28. A computer-readable medium carrying one or more sequences of instructions which, when executed by one or more processors, causes the one or more processors to perform the method recited in claim 11.

29. A computer-readable medium carrying one or more sequences of instructions which, when executed by one or more processors, causes the one or more processors to perform the method recited in claim 12.

30. A computer-readable medium carrying one or more sequences of instructions which, when executed by one or more processors, causes the one or more processors to perform the method recited in claim 13.

31. A computer-readable medium carrying one or more sequences of instructions which, when executed by one or more processors, causes the one or more processors to perform the method recited in claim 14.

32. A computer-readable medium carrying one or more sequences of instructions which, when executed by one or more processors, causes the one or more processors to perform the method recited in claim 15.

33. A computer-readable medium carrying one or more sequences of instructions which, when executed by one or more processors, causes the one or more processors to perform the method recited in claim 16.

34. A computer-readable medium carrying one or more sequences of instructions which, when executed by one or more processors, causes the one or more processors to perform the method recited in claim 17.
